(19) United States
(12) Patent Application Publication
(10) Pub. No.: US 2016/0187244 A1
(43) Pub. Date: Jun. 30, 2016

(54) Thermal fatigue tester

(71) Applicant: Research & Business Foundation Sungkyunkwan University, Suwon-si (KR)

(72) Inventors: Changsung SEOK, Gwacheon-si (KR); Yongseok KIM, Incheon (KR); Dong Keun LEE, Giseong-myeon (KR)

(73) Assignee: Research & Business Foundation Sungkyunkwan University, Suwon-si (KR)

(21) Appl. No.: 14/757,526

(22) Filed: Dec. 23, 2015

(30) Foreign Application Priority Data
Dec. 24, 2014 (KR) 10-2014-0188181

(51) Int. Cl. G01N 3/60

(52) U.S. Cl. CPC G01N 3/60

(57) ABSTRACT

Provided herein is a thermal fatigue tester capable of evaluating thermal fatigue characteristics of a test piece, the tester including a high temperature unit configured to create a temperature atmosphere for a high temperature thermal fatigue test of the test piece accommodated in an inner space; a low temperature unit arranged adjacent to one side of the high temperature unit and configured to create a temperature atmosphere for a low temperature thermal fatigue test of the test piece accommodated in an inner space; a convey unit configured to convey the test piece back and forth between the inner space of the high temperature unit and the inner space of the low temperature unit; and a shielding unit configured to seal at least the inner space where the test piece is accommodated of among the inner space of the high temperature unit and the inner space of the low temperature unit.

### CROSS-REFERENCE TO RELATED APPLICATION

This application claims the benefit of priority under 35 U.S.C. §119(a) of Korean Patent Application No. 10-2014-0188181, filed on Dec. 24, 2014, in the Korean Intellectual Property Office, the entire disclosure of which is incorporated herein by reference for all purposes.

### BACKGROUND

1. Field

The following description relates to a thermal fatigue tester, and more particularly, to a thermal fatigue tester capable of evaluating thermal fatigue characteristics of a test piece under two sealed atmospheric conditions (high temperature unit and low temperature unit).

2. Description of Related Art

The operation temperature of gas turbines for generators and airplane engines is on an increasing trend in order to obtain higher efficiencies. However, the base material of the metal material that includes a high heat-resistance alloy cannot withstand such severe temperature conditions, and thus a heat shield coating technology is being applied in order to protect the material from high temperature flames and high temperature oxidation. Generally, a heat shield coating consists of a ceramic top coating layer for insulation and a bond coating layer for bonding the ceramic top coating layer to the base metal. The difference of thermal expansion coefficients between these two materials (ceramic top coating and base metal) generates a thermal stress between the two layers, which is known as one of the most significant causes to damaging the heat shield coating system. Especially, the rapid temperature changes that occur when initiating and stopping operation of a gas turbine is known as a cause that generates a great thermal stress inside the heat shield coating.

Generally, in a thermal fatigue test, a high temperature and room temperature atmospheric temperature are applied. However, in practice, most gas turbines go through a pre-heating process before initiating or stopping operation, and the different pre-heating temperatures are applied depending on the type of the gas turbine. Therefore, performing a thermal fatigue test with the low temperature portion generalized to room temperature becomes a reason to fail exactly simulating various operating environment conditions of a heat shield coating.

Furthermore, oxidation is known as another cause for damaging a heat shield coating. In the case of a thermal fatigue test that is generally performed, cooling is performed in the air, and thus the test piece contacts oxygen, and is thus oxidized. In such a case, oxidation and thermal fatigue simultaneously act on the damaging of the heat shield coating, which makes it difficult to evaluate the exact damaging effect caused by thermal fatigue.

### SUMMARY

Therefore, a purpose of the present disclosure is to resolve the aforementioned problems of conventional technologies, that is to provide a thermal fatigue tester wherein two sealed atmospheric conditions (high temperature unit and low temperature unit) are formed so as to perform a thermal fatigue test on a test piece between two desired temperature conditions.

Another purpose of the present disclosure is to provide a thermal fatigue tester that may be filled with a gas for preventing oxidation of a test piece and sealed so as to perform a thermal fatigue test with any effect from the oxidation excluded.

According to an aspect, there is provided a thermal fatigue tester capable of evaluating thermal fatigue characteristics of a test piece, the tester including a high temperature unit configured to create a temperature atmosphere for a high temperature thermal fatigue test of the test piece accommodated in an inner space; a low temperature unit arranged adjacent to one side of the high temperature unit and configured to create a temperature atmosphere for a low temperature thermal fatigue test of the test piece accommodated in an inner space; a convey unit configured to convey the test piece back and forth between the inner space of the high temperature unit and the inner space of the low temperature unit; and a shielding unit configured to seal at least the inner space where the test piece is accommodated of among the inner space of the high temperature unit and the inner space of the low temperature unit.

Herein, the convey unit may desirably be configured in an axis format arranged side by side with an arrangement direction of the high temperature unit and low temperature unit.

Furthermore, the shielding unit may be provided in plural that may each seal the inner space of the high temperature unit and the inner space of the low temperature unit and such that they are spaced from each other on the convey unit.

Furthermore, the tester may desirably further include a driving means configured to move the convey unit back and forth in an axial direction.

Furthermore, low temperature unit may be desirably provided with a refrigerant supply pipe configured to control a cooling temperature.

Furthermore, the tester may desirably further include a gas supply unit configured to supply gas for preventing oxidation in at least the inner space where the test piece is accommodated of among the inner space of the high temperature unit and the inner space of the low temperature unit.

According to the present disclosure, there is provided a thermal fatigue tester wherein two sealed atmospheric conditions (high temperature unit and low temperature unit) are formed so as to perform a thermal fatigue test on a test piece between two desired temperature conditions.

Furthermore, there is provided a thermal fatigue tester that may be filled with a gas for preventing oxidation of a test piece in internal spaces of a high temperature unit and low temperature unit so as to perform a thermal fatigue test with any effect from the oxidation excluded.

Other features and aspects will be apparent from the following detailed description, the drawings, and the claims.

### BRIEF DESCRIPTION OF THE DRAWINGS

FIG. 1 is a schematic diagram illustrating a configuration of a thermal fatigue tester according to the present disclosure; and

FIG. 2 is a diagram illustrating the action of a thermal fatigue tester according to the present disclosure.

### DETAILED DESCRIPTION

Components that are configured the same in various embodiments will be explained with reference to the first embodiment using the same reference numerals, and only the components that are configured differently will be explained with reference to other embodiments.

Hereinafter, a thermal fatigue tester according to a first embodiment of the present disclosure will be explained in detail with reference to the drawings attached.

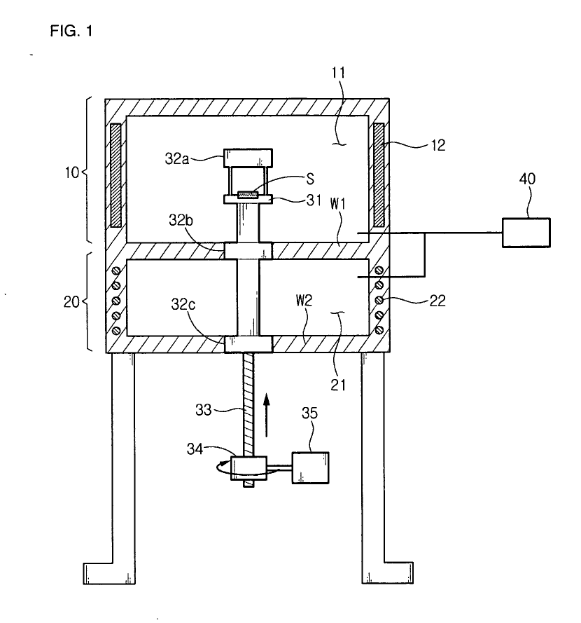

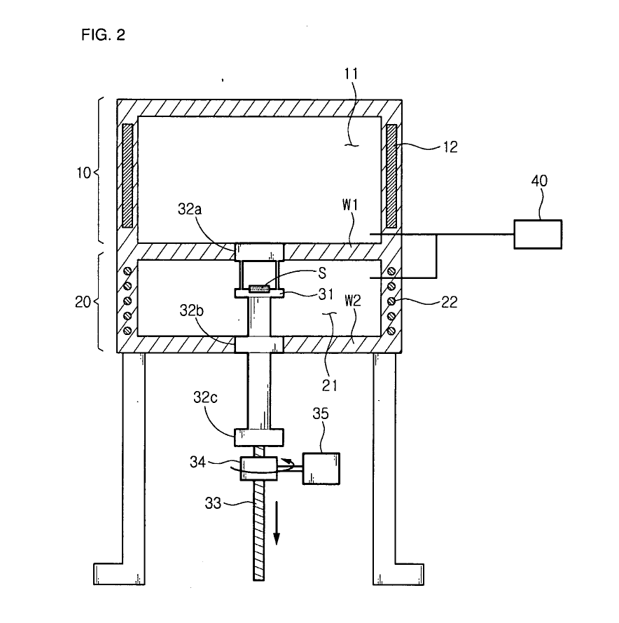

Of the attached drawings, FIG. 1 is a schematic diagram illustrating a configuration of a thermal fatigue tester according to the present disclosure; and FIG. 2 is a diagram illustrating the action of a thermal fatigue tester according to the present disclosure.

The thermal fatigue tester according to the present disclosure illustrated in the drawings is for evaluating the thermal fatigue characteristics of a test piece (S). The thermal fatigue tester includes a high temperature unit 10, low temperature unit 20, convey unit, and gas supply unit 40.

The high temperature unit 10 includes a chamber provided with an inner space 11 that may accommodate a test piece (S), and a heating unit 12 arranged to surround the inner space 11 and configured to control the temperature of the inner space 11 for a high temperature thermal fatigue test.

The low temperature unit 20 includes a chamber arranged at one side of the high temperature unit and provided with an inner space 21 that may accommodate a test piece (S), and a heat absorbing unit 22 arranged to surround the inner space 21 of the chamber and configured to control the temperature for a low temperature thermal fatigue test that is relatively lower than the temperature of the high temperature unit 10.

Specifically, as illustrated in the drawings, the high temperature unit 10 and low temperature 20 are continuously arranged above and below, and a first wall (W1) arranged between the high temperature 10 and low temperature 20 and a second wall (W2) arranged below the low temperature unit 20 are partially open. The test piece (S) may be selectively arranged in the inner space 21 of the low temperature unit 20 or in the inner space 11 of the high temperature unit 10 by the convey unit that penetrates the open areas of the first wall (W1) and second wall (W2) and travels back and forth in an axial

The convey unit is configured to convey the test piece (S) back and forth between the inner space 11 of the high temperature unit 10 and the inner space 21 of the low temperature unit 20. A front end of the convey unit is configured in an axial shape that may penetrate the low temperature unit 20 and be inserted into the high temperature unit 10, and a test piece fixing unit 31 is formed on the front end to fixate the test piece (S). Furthermore, on an outer circumference of the convey unit, a plurality of shielding units 32a, 32b, 32c are arranged that seal the inner space 11 of the high temperature unit 10 and the inner space 21 of the low temperature unit 20 at a first position where the test piece fixing unit 31 is located inside the high temperature unit 10 and at a second position where the test piece fixing unit 31 is located inside the low temperature unit 20, respectively, and at another end of the convey unit, a driving means is provided for conveying the convey unit back and forth in an axial direction. Such a driving means may include a driving motor 35, a ball nut 34 configured to rotate in a forward or backward direction by the driving of the driving motor 35, and a ball screw 33 formed on an outer circumference of the another end of the convey unit and configured to engage the ball nut 34.

Specifically, as illustrated, the plurality of shielding units 32a, 32b, 32c formed on the outer circumference of the convey unit may include a first shielding unit 32a formed at an uppermost end of the convey unit, a second shielding unit 23b spaced from the first shielding unit 32a by a predetermined distance having the test piece fixing unit 31 between itself and the first shielding unit 32a, and a third shielding unit 32c spaced from the second shielding unit 32b by a predetermined distance. Herein, it is desirable that the distance between the shielding units 32a, 32b, 32c is set to correspond to the axial direction distance of the convey unit in the low temperature unit 20.

Therefore, when the convey unit moves to the first position and thus the test piece (S) is arranged in the inner space 11 of the high temperature unit 10, the second shielding unit 32b may seal the opening area of the first wall (W1) located between the high temperature unit 10 and low temperature unit 20, and the third shielding unit 32c may seal the opening area of the second wall (W2) located below the low temperature unit 20, thereby sealing the inner spaces (11, 21) of the high temperature unit (10) and low temperature unit (20), respectively.

The gas supply unit 40 adjusts the gas atmosphere of the inner spaces 11, 21 in order to prevent oxidation of the test piece (S) being accommodated in the inner space 11 of the high temperature unit 10 or the inner space 21 of the low temperature unit 20. The gas being supplied to the high temperature unit 10 or low temperature unit 20 by the gas supply unit 40 may desirably include inert gases such as helium, argon, and nitrogen so as to prevent oxidation of the test piece (S).

According to the embodiment of the thermal fatigue tester configured as aforementioned, when the test piece (S) is arranged in the inner space 11 of the high temperature unit 10 by the convey unit moved to the first position, the inner space 11 of the high temperature unit 10 is maintained at a temperature suitable to the high temperature thermal fatigue test by the heating unit 12 arranged to surround the high temperature unit.

Furthermore, when the convey unit moves to the first position, the second shielding unit 32b located on the convey unit seals the opening area of the first wall (W1) arranged below the high temperature unit 10, and in the inner space 11 of the high temperature unit 10 sealed by the second shielding unit 32b, a gas atmosphere for preventing oxidation of the test piece (S) is created by the gas being supplied from the gas supply unit 40. Therefore, the test piece (S) may be prevented from being damaged by the oxidation phenomenon during a high temperature thermal fatigue test process of the test piece (S).

Hereinafter, explanation will be made on an operation of the test piece (S) being moved to the inner space 21 of the low temperature unit 20 by a drive of the convey unit in the aforementioned thermal fatigue tester.

Of the attached drawings, FIG. 2 is a diagram illustrating the action of a thermal fatigue tester according to the present disclosure.

As illustrated in the drawings, when the ball nut 34 is rotated in one direction by the motor 35, the ball screw 33 engaging the ball nut 34 will move, thereby moving the convey unit from the first position to the second position. In this process, the test piece (S) fixed on the test piece fixing unit 31 of the convey unit will be arranged in the inner space 21 of the low temperature unit 20.

The inner space 21 of the low temperature unit 20 is maintained at a temperature suitable to the low temperature thermal fatigue test by the heat absorbing unit 22 such as a refrigerant supply pipe arranged to surround the low temperature unit 20. Furthermore, the opening area of the first wall (W1) arranged above the low temperature unit 20 is sealed by the first shielding unit 32a located on a top end of the convey unit, and the opening area of the second wall (W2) arranged below the low temperature unit 20 is sealed by the second shielding unit 32b formed in the middle of the convey unit.

Therefore, in the inner space 21 of the low temperature unit 20 sealed by the first shielding unit 32a and second shielding unit 32b, a gas atmosphere for preventing oxidation of the test piece (S) is created by the gas being supplied from the gas supply unit 40, and thus it is possible to prevent the test piece (S) from being damaged by the oxidation phenomenon in the low temperature thermal fatigue test process of the test piece (S).

Meanwhile, although it was explained in the present embodiment that the second shielding unit 32b and third shielding unit 32c are configured independently from each other and are arranged to be distanced on the convey unit, it is possible to configure the second shielding unit 32b and third shielding unit 32c in an integral format so as to prevent the gas for preventing oxidation filled in the low temperature unit 20 from leaking outside in the process where the convey unit moves back and forth between the first position and second position.

The right of the scope of the present disclosure is not limited to the aforementioned embodiments but may be realized in various types of embodiments within the claims attached hereto. It will be apparent to one of ordinary skill in the art that various changes in form and details may be made in these examples without departing from the spirit and scope of the claims and their equivalents.

### REFERENCE NUMERALS

10: HIGH TEMPERATURE UNIT
11: INNER SPACE
12: HEATING UNIT
20: LOW TEMPERATURE UNIT
21: INNER SPACE
22: HEAT ABSORBING UNIT
W1: FIRST WALL
W2: SECOND WALL
31: TEST PIECE FIXING UNIT
32A, 32B, 32C: SHIELDING UNITS
33: BALL SCREW
34: BALL NUT
35: MOTOR
40: GAS SUPPLY UNIT

What is claimed is:

1. A thermal fatigue tester capable of evaluating thermal fatigue characteristics of a test piece, the tester comprising:
a high temperature unit configured to create a temperature atmosphere for a high temperature thermal fatigue test of the test piece accommodated in an inner space;
a low temperature unit arranged adjacent to one side of the high temperature unit and configured to create a temperature atmosphere for a low temperature thermal fatigue test of the test piece accommodated in an inner space;
a convey unit configured to convey the test piece back and forth between the inner space of the high temperature unit and the inner space of the low temperature unit; and
a shielding unit configured to seal at least the inner space where the test piece is accommodated of among the inner space of the high temperature unit and the inner space of the low temperature unit.

2. The tester according to claim 1,
wherein the convey unit is configured in an axis format arranged side by side with an arrangement direction of the high temperature unit and low temperature unit.

3. The tester according to claim 2,
wherein the shielding unit is provided in plural that may each seal the inner space of the high temperature unit and the inner space of the low temperature unit and such that they are spaced from each other on the convey unit.

4. The tester according to claim 2,
further comprising a driving means configured to move the convey unit back and forth in an axial direction.

5. The tester according to claim 1,
wherein the low temperature unit is provided with a refrigerant supply pipe configured to control a cooling temperature.

6. The tester according to any one of claims 1 to 5,
further comprising a gas supply unit configured to supply gas for preventing oxidation in at least the inner space where the test piece is accommodated of among the inner space of the high temperature unit and the inner space of the low temperature unit.
